(19) United States
(12) Patent Application Publication
(10) Pub. No.: US 2009/0211266 A1
(43) Pub. Date: Aug. 27, 2009

(54) Method of controlling ice making assembly for refrigerator

(76) Inventors: Young Jin Kim, Seoul (KR); Tae Hee Lee, Seoul (KR); Hong Hee Park, Seoul (KR); Ho Youn Lee, Seoul (KR); Joon Hwan Oh, Seoul (KR)

Correspondence Address: MCKENNA LONG & ALDRIDGE LLP, 1900 K STREET, NW, WASHINGTON, DC, 20006, US

(21) Appl. No.: 12/379,438

(22) Filed: Feb. 20, 2009

(30) Foreign Application Priority Data
Feb. 27, 2008 (KR) 10-2008-0017606
Feb. 27, 2008 (KR) 10-2008-0017611

(51) Int. Cl. F25C 1/00; G05B 15/00

(52) U.S. Cl. 62/66; 700/275

(57) ABSTRACT

Controlling an ice making assembly for a refrigerator such that the ice making assembly produces transparent ice. Transparent ice can be produced even if the space containing the ice making assembly is kept at a temperature lower than 0° C. This is achieved, in part, by maintaining the ice tray at a temperature at or above freezing.

### CROSS-REFERENCE TO RELATED APPLICATIONS

The present application claims priority under 35 U.S.C. 119 and 35 U.S.C. 365 to Korean Patent Application Nos. 10-2008-0017606 and 10-2008-0017611, both filed on Feb. 27, 2008, which are hereby incorporated by reference in their entirety.

### BACKGROUND

The present disclosure relates to a method of controlling a refrigerator ice making assembly for making transparent ice.

Refrigerators are domestic appliances used for storing foods by refrigerating or freezing the foods. Various kinds of refrigerators have been introduced into the market. Examples of such refrigerators include: a side by side type refrigerator in which a refrigerator compartment and a freezer compartment are disposed in the left and right sides; a bottom freezer type refrigerator in which a refrigerator compartment is disposed above a freezer compartment; and a top mount type refrigerator in which a refrigerator compartment is disposed under a freezer compartment.

Some, more recent refrigerators have a home bar structure that allows users to access foods or drinks disposed inside a refrigerator compartment through the home bar without having to open a refrigerator compartment door. A refrigerator includes various refrigeration cycle components. A compressor, a condenser, and an expansion member are generally disposed inside the refrigerator. An evaporator is generally disposed on the backside of a refrigerator main body.

In addition, many refrigerators include an ice making assembly provided inside the refrigerator. The ice making assembly may be mounted in the freezer compartment, in the refrigerator compartment, on the freezer compartment door, or on the refrigerator compartment door.

More recently, consumers have begun demanding that the ice making assemblies be capable of making transparent ice, that is, ice that does not appear cloudy due to the fact that gas, such as air, is trapped in the ice when frozen.

### SUMMARY

The exemplary embodiments set forth herein provide a method of controlling a refrigerator ice making assembly for making transparent ice.

The exemplary embodiments set forth herein further provide a method of controlling a refrigerator ice making assembly by adjusting the temperature of a tray to make transparent ice.

In accordance with one aspect of the present invention, a method is provided that controls a refrigerator ice making assembly, the method including: supplying water to an ice recess formed in a tray; moving a rod into the ice recess; cooling the rod; and operating a tray heater intermittently during an ice making operation to maintain the tray at one or more temperatures equal to or higher than a water freezing temperature.

Because the tray is kept at a temperature or temperatures higher than a water freezing temperature during the ice making operation, water freezes more slowly and in a direction from the surface of the rod towards the surface of the ice recess. Therefore, while the water freezes, air dissolved in the water can escape from the water before it is trapped in ice. It is the air trapped in the ice that causes the ice to appear cloudy. Because the air does escape, the ice that is produced is transparent.

Furthermore, the size of ice pieces and the amount of residual water remaining in the tray can be efficiently controlled by varying the number of tray temperature reducing operations during the ice making operation, while at the same time producing very transparent ice.

The details of the one or more exemplary embodiments are set forth in the accompanying drawings and the description below. Other features will be apparent from the description and drawings, and from the appended claims.

### BRIEF DESCRIPTION OF THE DRAWINGS

FIGS. 1 and 2 are perspective views illustrating an ice making assembly for a refrigerator in accordance with exemplary embodiments of the present invention.

FIG. 3 is a perspective view illustrating an ice making assembly according to exemplary embodiments of the present invention.

FIG. 4 is a perspective view illustrating the ice making assembly just before ice is transferred to a container.

FIG. 5 is a perspective view illustrating the ice making assembly tray according to exemplary embodiments of the present invention.

FIG. 6 is a sectional view illustrating a process of making transparent ice according to exemplary embodiments of the present invention.

FIG. 7 is a flowchart of a method for controlling the temperature of the ice making assembly tray according to exemplary embodiments of the present invention.

FIG. 8 is a graph illustrating an exemplary temperature distribution for the tray according to the method of FIG. 7.

### DETAILED DESCRIPTION OF THE EMBODIMENTS

Hereinafter, refrigerator ice making assembly will be described in detail according to exemplary embodiments. The ice making assembly will also be described with reference to the accompanying drawings.

In the following description, an ice making assembly is mounted on a freezer compartment door. However, the ice making assembly can be mounted elsewhere, such inside the freezer compartment, inside the refrigerator compartment, or on the refrigerator compartment door.

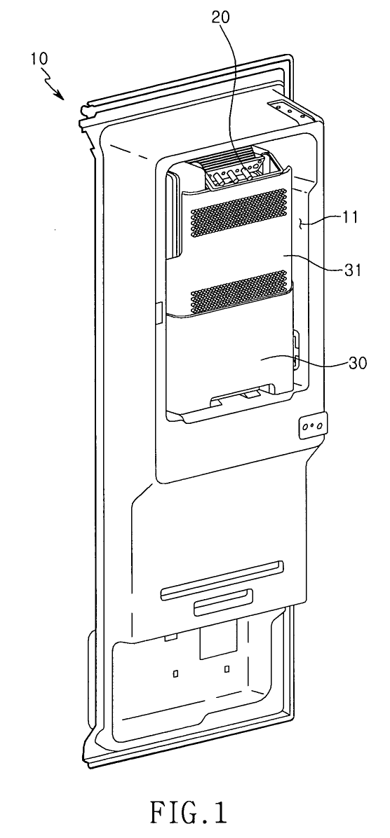

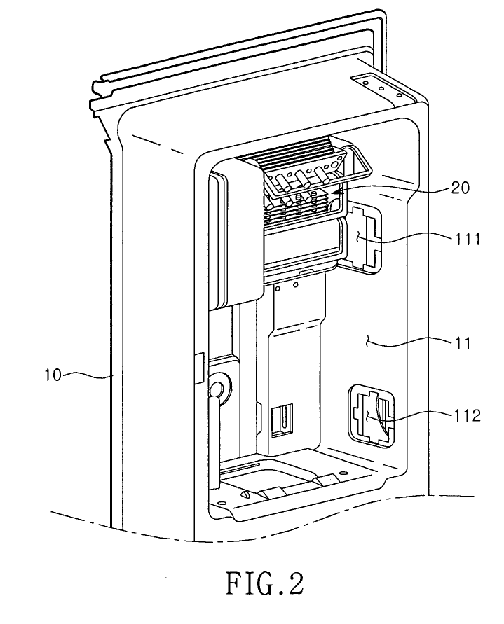

FIGS. 1 and 2 are perspective views illustrating a refrigerator ice making assembly according to exemplary embodiments of the present invention. Referring to FIGS. 1 and 2, ice making assembly 20 is mounted on the backside of door 10, where the backside of the door 10 includes a recessed space 11 for accommodating the ice making assembly 20. A cooling air supply hole 111 is formed through one side wall that forms the recessed space 11. The air supply hole 111 allows for the inflow of cooling air from an evaporator (not shown). A cooling air discharge hole 112 is also formed on one of the side walls that form the recessed space 11. The cooling air discharge hole 112 allows for the outflow of cooling air from the ice making recessed space 11 to the evaporator.

More specifically, the ice making assembly 20 is mounted in an upper portion of the recessed space 11, and a container 30 is mounted under the ice making assembly 20 to store ice that has already been produced by the ice making assembly 20. The ice making assembly 20 is protected by an ice making cover 31. The ice making cover 31 prevents ice from missing the container 30 when released from the ice making assembly 20.

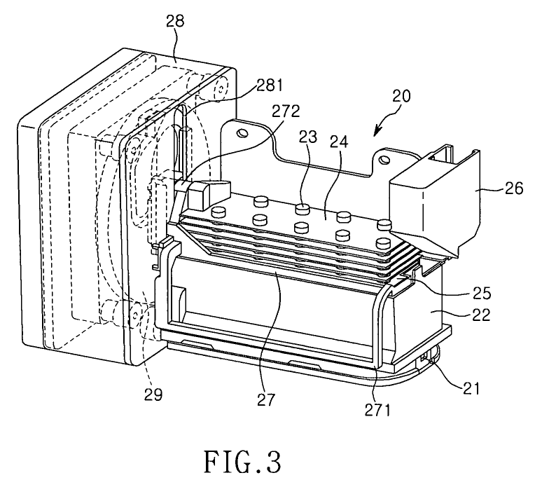

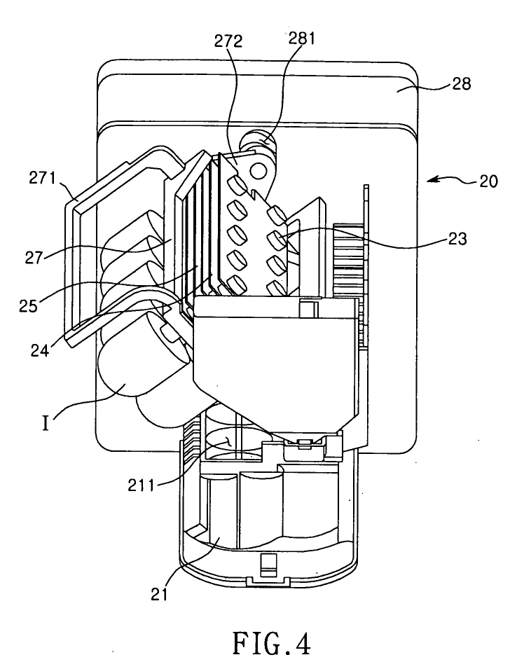

FIG. 3 is a perspective view illustrating the ice making assembly 20 according to exemplary embodiments. FIG. 4 is a perspective view illustrating the ice making assembly 20 just before ice is released and transferred to the container 30. Referring to FIGS. 3 and 4, the ice making assembly 20 includes a tray 21 having a plurality of ice recesses 211 which form the ice into a predetermined shape; a plurality of fins 24 rotatably and movably stacked above the tray 21; a plurality of rods 23 which project through the fins 24 and are configured such that each of the rods 23 is inserted into a corresponding one of the ice recesses 211; an ice ejecting heater 25 provided at the lowermost fin 24; a supporting plate 27 configured to support the ice ejecting heater 25, the fins 24, and the rods 23 as one unit; a water supply part 26 disposed at an end of the tray 21; and a control box 28 disposed at one end of the tray 21.

Further, with reference to FIGS. 3 and 4, a heater (not shown) is mounted at the bottom of the tray 21 to maintain the tray 21 at a temperature higher than a water freezing temperature. A supporting lever 271 extends from a front side of the supporting plate 27, and a hinge 272 is formed at one end of the supporting plate 27, for example, as shown in FIG. 4. During an ice making operation, ice pieces (I) having a shape corresponding to the shape of the ice recesses 211 are formed around the rods 23.

A cam 29 and a driving motor for actuating the cam 29 are disposed inside the control box 28. The hinge 272 is connected to the cam 29 so that the hinge 272 can be lift and rotated by rotating the cam 29. The ice ejecting heater 25 may have the shape of a plate contacting the rods 23. Alternatively, the ice ejecting heater 25 may be contained internal to each of the rods 23. The supporting plate 27 closes an opened top side of the tray 21 such that water supplied to the tray 21 is indirectly cooled by the cooling air supplied to the recessed space 11.

Hereinafter, ice making and ice ejecting operations associated with the ice making assembly 20 will now be described. First, the heater attached to the tray 21 is employed to maintain the tray 21 at a temperature higher than 0° in order to produce transparent ice. In more detail, when water is rapidly frozen by cooling air supplied from an evaporator in the related art, air dissolved in the water cannot be discharged from the water during freezing. When the gas is trapped in the frozen water, the ice appears cloudy (i.e., non-transparent). Therefore, in the ice making assembly 20, the tray 21 is kept at a temperature higher than a water freezing temperature to freeze water more slowly so that air dissolved in the water has time to escape from the water before the water freezes. The more gradual freezing process results in transparent ice.

After the rods 23 are positioned in the ice recesses 211 of the tray 21, and after water is supplied to the tray 21, the freezing operation is initiated. The freezing operation is initiated by supplying cooling air to the ice making recessed space 11. In addition, the temperature of the fins 24 is reduced to a temperature below a water freezing temperature by the supplied cooling air. This causes the temperature of the rods 23 to drop below the freezing temperature through the process of conduction with the fins 24. Here, Portions of the rods 23 are, as stated, positioned within the ice recesses 211 and submerged in the water. Therefore, the water gradually freezes starting with water located closest to rods 23. The water continues to freeze from the outer surface of the rods 23 towards the inner surface of the ice recesses 211.

After the water freezing operation is completed, the cam 29 is rotated to move the rods 23 out of the ice recesses 211. That is, the cam 29 is rotated which causes the rods 23 and the attached ice pieces (I) to be taken out of the ice recesses 211. The cam 29 continues to rotate causing the rods 23 to be positioned at a predetermined angle.

The completion of the water freezing operation may be determined based on a predetermined amount of time; thus, when that time has elapsed, the water freezing operation is completed.

Alternatively, the cam 29 is driven so as to lift the rods 23 to a predetermined height after a predetermined period of time has elapsed. Here, the predetermined height may mean a height at which ice attached to the rods 23 has not fully cleared the ice recesses 211. At this point, the amount of unfrozen water remaining in the bottom of the ice recesses 211 is determined. If the amount of water remaining in the ice recesses 211 is equal to or less than a predetermined amount, it may be determined that the freezing operation is completed. The amount of water remaining in the ice recesses 211 can be detected using a water level sensor mounted on the tray 21. On the other hand, if the amount of water remaining in the ice recesses 211 is greater than the predetermined amount, the rods are repositioned to their original positions relative to the ice recesses 211 to continue the water freezing operation. The water sensor will be described later with reference to the accompanying drawings.

As described above, after the water freezing operation is completed, the cam 29 is rotated to lift the rods out of the ice recesses 211. That is, the cam 29 is rotated to lift the rods 23 and the attached ice pieces (I) until they clear the ice recesses 211. The cam 29 continues to rotate along with the hinge 272 which causes the rods 23 to tilt at a predetermined angle. FIG. 4 illustrates the rods 23 and ice pieces (I) tilted at the predetermined angle. Then, the ice ejecting heater 25 is operated.

When the ice ejecting heater 25 is operated, the temperature of the rods 23 increases. This eventually causes the ice pieces (I) to separate from the rods 23. The separated ice pieces (I) fall into the container 30.

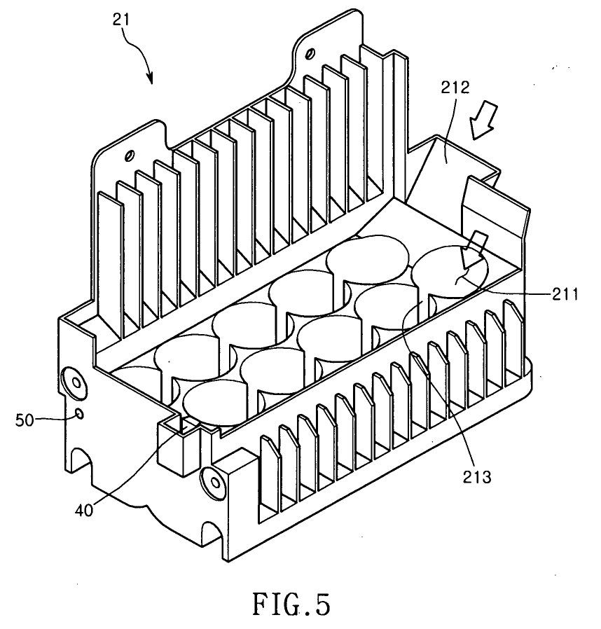

FIG. 5 is a perspective view illustrating the tray 21 of the ice making assembly 20 according to exemplary embodiments of the present invention. Referring to FIG. 5, in the tray 21 of the ice making assembly 20, the ice recesses 211 are arranged. Grooves 213 having a predetermined depth are formed between the ice recesses 211. In this regard, water can be transferred between neighboring ice recesses 211 through the grooves 213. The bottom of the grooves 213 are at a predetermined height above the bottom of the ice recesses 211.

Additionally, a guide 212 is formed at one end portion of the tray 21, as illustrated, to guide water supplied through water supply part 26 can be guided to the tray 21 and into the ice recesses 211. Water is supplied to the ice recesses 211 gradually starting with the ice recess 211 closest to the guide 212 and, eventually, the ice recess 211 farthest from the guide 212.

A water level sensor 40 is mounted at one side of the ice recess 211, preferably, farthest from the guide 212. Further, a temperature sensor 50 is mounted at one side of the tray 21 to assist in maintaining the tray 21 at a particular temperature or temperatures, as will be explained in greater detail below. A tray heater (not shown) is installed in or next to the tray 21.

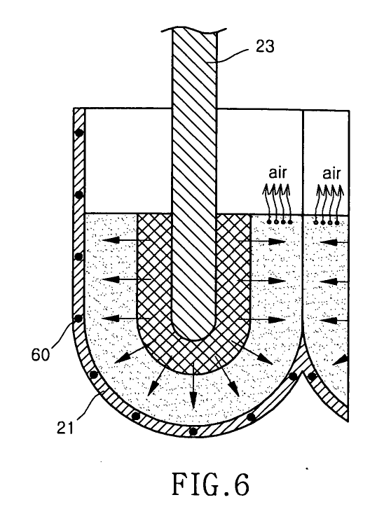

FIG. 6 is a sectional view illustrating the process which results in transparent ice in the ice making assembly 20 in accordance with exemplary embodiments of the present invention. Referring to FIG. 6, a tray heater 60 is installed in the tray 21 of the ice making assembly 20, as shown. After the rod 23 is positioned within the ice recess 211, the recess is filled with water. Of course, it is possible to first fill the ice recess 211 with water and then position the rod 23 within the ice recess 211 as shown.

The water freezing operation then begins. At this point, the fins 24 are cooled by cooling air supplied to the recessed space 11. By way of conduction, this causes the temperature of rod 23 to cool below a water freezing temperature. When the temperature of the rod 23 reaches a temperature below the water freezing temperature, begins to form around the rod 23. At this time, the tray heater 60 operates to maintain the tray 21 at a temperature higher then 0° C. For example, the tray 21 may be kept approximately at a temperature between 1° C to 2° C. According to the Henry's law, the amount of gas that can be dissolved in water is reduced as the temperature of the water increases. Therefore, the air dissolved in the water can be more effectively removed from the water by operating the tray heater 60 and maintaining the temperature of the tray 21 above 0° C. At the same time, ice is gradually formed from the surface of the rod 23 outward toward the surface of the ice recess 211.

Because the tray 21 is kept at a temperature higher than the water freezing temperature, ice is not attached to the inner surface of the tray 21 (i.e., the surface of the ice recess 211) even after the ice making operation is completed. And, in addition, a predetermined amount of water remains in the ice recess 211 after the ice making operation.

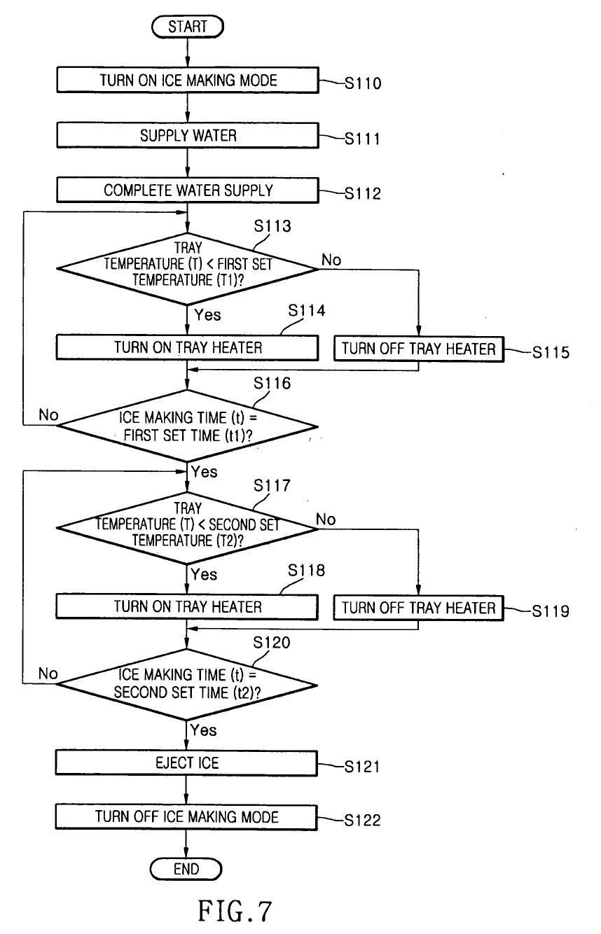

FIG. 7 is a flowchart illustrating a method of controlling the temperature of the tray 21 of the ice making assembly 20 according to exemplary embodiments of the present invention. Referring to FIG. 7, the temperature of the tray 21 can be controlled in multiple steps so that high-quality transparent ice can be made. That is, the temperature of the tray 21 is reduced stepwise which promotes the removal of the air from the water more rapidly, thereby increasing the ice making speed and minimizing the amount of water remaining in the ice recesses 211.

First, an ice making mode is initiated by a user or by a refrigerator control unit (operation S110). In more detail, the ice making mode can be initiated by the refrigerator control unit when an automatic ice making operation is necessary, for example, when it is detected by an ice detecting unit that the amount of ice stored in the container 30 is less than a predetermined amount.

After the ice making mode is initiated, water is supplied (operation S111) to the tray 21. Water is continuously supplied until the water level in the tray 21 reaches a preset level (operation S112). Water level sensor 40 can be used to determine when the water level reaches the preset level. Next, cooling air is supplied to the recessed space 11 to cool the rods 23. As the rods 23 cool, the water in the ice recess 211 of the tray 21 starts to freeze.

Meanwhile, the temperature of the tray 21 is detected using temperature sensor 50. More specifically, temperature sensor 50 is used to determine whether the temperature T of the tray 21 is lower than a first set temperature T1 (operation S113). If the tray temperature T is lower than the first set temperature T1, the tray heater 60 is turned on (operation S114). As previously stated, the temperature of the tray 21 is kept at a temperature higher than the freezing temperature by the operation of the tray heater 60 so that air dissolved in the water can be prevented from freezing together with the water. If it is determined that the tray temperature T is equal to or higher than the first set temperature T1, the tray heater 60 is turned off (operation S115). Here, the turning-off of the tray heater 60 includes the case where the tray heater 60 was previously turned off and kept in the off state.

Then a determination is made as to whether the ice making time (t) reaches a first set time t1 (operation S116) If the ice making time (t) has not yet reached the first set time t1, the tray temperature detecting operations (operations S113, S114, and S115) are repeated.

If the ice making time (t) reaches the first set time t1, a determination is made as to whether the tray temperature T is lower than a second set temperature T2 (S117), where the second set temperature T2 is lower than the first set temperature T1. That is, the tray 21 is maintained at the first set temperature T1 for the first set time t1, and after ice begins to form during the first set time t1, the tray 21 is kept at the second set temperature T2. By reducing the tray temperature T stepwise from T1 to T2, larger ice pieces having good transparency can be made. That is, by reducing the tray temperature T stepwise, the amount of water remaining in the ice recess 211 after the ice making operation can be reduced. Therefore, relatively larger ice pieces can be obtained by increasing the number of tray temperature reducing operations, and smaller ice pieces can be obtained by reducing the number of the tray temperature reducing operations. Both the first set temperature T1 and the second set temperature T2 may be higher than the freezing temperature.

Moreover, if the tray temperature T is lower than the second set temperature T2, the tray heater 60 is turned on (operation S118). On the other hand, if the tray temperature T is equal to or higher than the second set temperature T2, the tray heater 60 is turned off (operation S119). These operations are the same as the above-described operations for maintaining the tray temperature T at the first set temperature T1. Thereafter, a determination is made as to whether the ice making time (t) reaches a second set time t2 (operation S120). If it is determined that the ice making time (t) has not yet reached the second set time t2, the operations S117, S118, and S119 are repeated for maintaining the tray temperature T at the second set temperature T2. When it is determined that the ice making time (t) has reached the second set time t2, the ice is ejected and the ice making mode is turned off (operation S122).

The tray heater 60 may be controlled using an on/off relay. However, the tray heater 60 could also be controlled using a semiconductor switch such as a TRIAC or a thyristor. That is, depending on the temperature of the tray 21, a voltage (a current) applied to a switch can be varied. For example, when the temperature of the tray 21 is lower than a set temperature, a voltage (a current) applied to the tray heater 60 can be increased to further heat the tray 21. If the temperature of the tray 21 is equal to or higher than the set temperature, the voltage (current) applied to the tray heater 60 can be decreased to reduce the temperature of the tray 21.

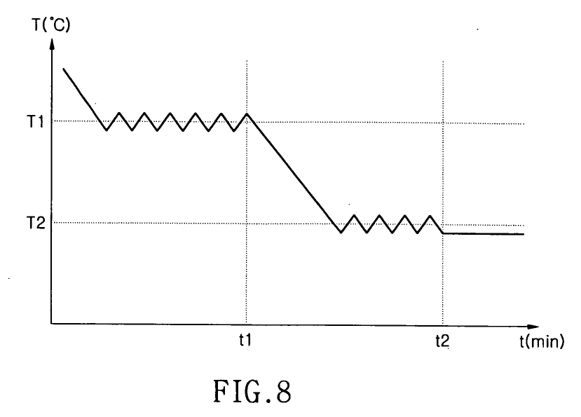

FIG. 8 is a graph illustrating a temperature distribution of the tray 21 according to the method of FIG. 7. Referring to FIG. 8, the tray heater 60 is intermittently turned on and off to maintain the tray 21 at the first set temperature T1. After the tray 21 is maintained at the first set temperature T1 for the first set time t1, the tray 21 is maintained at the second set temperature T2 for the second set time t2, in much the same way.

While the tray 21 is maintained at the first set temperature T1 for the first set time t1, the size of an ice pieces increase. After the first set time t1 elapses, the temperature of the tray 21 is reduced to the second set temperature T2 to increase the size of the ice pieces and to reduce the amount of water remaining in the tray 21 after the ice making process is complete. In a preferred embodiment, both temperatures T1 and T2 are higher than the freezing.

In the above-described exemplary embodiment, the temperature of the tray 21 is reduced in two steps. However, the scope of the present disclosure is not limited thereto. That is, as the number of steps increases, larger ice pieces can be obtained, and the amount of remaining water can be reduced. The number of steps for reducing the temperature of the tray 21 can be determined by a user.

As described above, by reducing the temperature of the tray 21 stepwise, transparent ice can be made, and the amount of remaining water can be reduced. Further, by varying the number of tray temperature reducing operations, the size of the ice pieces can be adjusted.

Instead of operating the tray heater 60 to reduce the temperature of the tray 21 stepwise, the tray heater 60 can be operated to maintain the temperature of the tray 21 at a constant temperature higher than the freezing temperature until the ice making process is completed.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of controlling an ice making assembly for a refrigerator, the method comprising:
supplying water to an ice recess formed in a tray;
repositioning a rod such that at least a portion of the rod is positioned in the ice recess;
cooling the rod; and
operating a tray heater during an ice making operation to maintain the tray at a temperature equal to or higher than a freezing temperature.

2. The method according to claim 1, wherein the tray heater is operated intermittently during the ice making operation.

3. The method according to claim 2, wherein the temperature of the tray is reduced during the ice making operation in at least one stepwise operation from the temperature to a lower temperature equal to or higher than a freezing temperature.

4. The method according to claim 2, wherein repositioning the rod occurs before the completion of supplying water to the ice recess.

5. The method according to claim 2, wherein cooling the rod comprises:
supplying cooling air to the space containing the ice making assembly.

6. The method according to claim 2, wherein the tray is maintained at a temperature equal to or higher than the freezing temperature until the ice making operation is completed.

7. The method according to claim 2, wherein the tray is maintained at a temperature equal to or higher than about 0° C. during the ice making operation by the operation of the tray heater.

8. The method according to claim 2, wherein the tray is maintained at a temperature equal to or higher than 0° C. during the ice making operation by the operation of the tray heater.

9. The method according to claim 2, wherein the tray is maintained at a temperature ranging from about 1° C. to about 2° C. during the ice making operation by the operation of the tray heater.

10. The method according to claim 2, wherein the tray is maintained at a first predetermined temperature higher than the freezing temperature for a first set period of time and, after the first set period of time expires, the tray is maintained at a second predetermined temperature lower than the first predetermined temperature for a second set period of time.

11. The method according to claim 10, wherein the temperature of the tray is reduced from the first predetermined temperature to the second predetermined temperature in a stepwise manner.

12. The method according to claim 2, wherein power is supplied to the tray heater through a switch.

13. The method according to claim 2, further comprising:
removing the rod from the ice recess after the ice making operation is complete;
rotating the rod by a predetermined angle; and
heating the rod, thereby causing the ice attached thereto to separate from the rod.

14. A method of controlling a refrigerator ice making assembly during an ice making operation where the ice making assembly includes a plurality of ice recesses formed in an ice tray, the method comprising:
repositioning a plurality of rods such that at least a portion of each rod is positioned in a corresponding one of the ice recesses;
supplying water to each of the ice recesses;
cooling the plurality of rods to a temperature below a water freezing temperature; and
successively maintaining the ice tray at a plurality of predetermined temperatures, for a plurality of corresponding time periods, wherein each of the predetermined temperatures is lower than the previous predetermined temperature, and wherein each of the predetermined temperatures is equal to or higher than the water freezing temperature.

15. The method according to claim 14, wherein the number of predetermined temperatures at which the ice tray is maintained is adjustable.

16. The method according to claim 15, wherein the number of predetermined temperatures at which the ice tray is maintained is proportional to the size of the ice produced by the ice making assembly.

17. The method according to claim 14, wherein successively reducing the temperature of the ice tray to each of the plurality of predetermined temperatures causes the ice to first form at the surface of each rod and progressively form ice in the direction of the surface of the ice recesses.

18. The method according to claim 14 further comprising:
removing the plurality of rods from the plurality of ice recesses when the ice making operation is completed;
adjusting the angle of the rods; and
heating each of the plurality of rods to a temperature that is sufficient to allow the ice attached thereto to separate from the rods and fall into an ice container associated with the ice making assembly.
